(19) United States
(12) Patent Application Publication
(10) Pub. No.: US 2026/0193918 A1
(43) Pub. Date: Jul. 9, 2026

(54) GUIDE ASSEMBLY FOR GUIDING A MOVABLE FURNITURE PART

(71) Applicant: Julius Blum GmbH, Hoechst (AT)

(72) Inventors: Lukas KOLHAUPT, Lauterach (AT); Thomas FOLIE, Dornbirn (AT); Markus IRGANG, Altach (AT); Lukas SCHREIBER, Feldkirch (AT); Manuel SCHMITT, Hoechst (AT); André HAMMERER, Alberschwende (AT)

(21) Appl. No.: 19/559,452

(22) Filed: Mar. 6, 2026

Related U.S. Application Data
(63) Continuation of application No. PCT/AT2024/060304, filed on Aug. 14, 2024.

(30) Foreign Application Priority Data
Sep. 7, 2023 (AT) A 50714/2023

(51) Int. Cl. E05D 15/06; E05D 15/58

(52) U.S. Cl. CPC E05D 15/0621; E05D 15/58; E05Y 2600/312; E05Y 2600/314; E05Y 2900/20

(57) ABSTRACT

A guide arrangement includes a guide system with a guide to be arranged on a stationary furniture part, a guide device displaceably mounted on the guide, a carrier to be fastened to a movable furniture part and which is movement-coupled to the guide device, at least two hinges for pivotably mounting the movable furniture part on the carrier, and a height adjustment device for adjusting the hinges relative to the guide system in a direction parallel to a longitudinal extension of the carrier. The height adjustment device includes an inclined surface for adjusting the hinges relative to the guide system in a direction parallel to the longitudinal extension of the carrier. A side adjustment device can adjust the hinges relative to the guide system in a direction orthogonal to the longitudinal extension of the carrier, and the height adjustment device and the side adjustment device form a common structural unit.

The present application is a continuation of International Application PCT/AT2024/060304 filed on Aug. 14, 2024. Thus, all of the subject matter of International Application PCT/AT2024/060304 is incorporated herein by reference.

### BACKGROUND OF THE INVENTION

The invention relates to a guide arrangement for guiding a movable furniture part, in particular a sliding door or folding-sliding door, relative to a stationary furniture part, in particular a furniture wall, comprising:
at least one guide system having a guide to be arranged on the stationary furniture part and a guide device displaceably mounted on the guide,
a carrier to which the movable furniture part is to be fastened and which is connected to the guide device in a movement-coupled manner,
at least two hinges for the pivotable mounting of the movable furniture part on the carrier, and
a height adjustment device for adjusting the at least two hinges relative to the at least one guide system in a direction parallel to a longitudinal extension of the carrier.

Furthermore, the invention relates to a piece of furniture with at least one stationary furniture part, in particular a furniture wall, and at least one movable furniture part, in particular a sliding door or folding-sliding door and such a guide arrangement.

Such guide arrangements are already known from the prior art. As a rule, to adjust the height, the at least two hinges are loosened, moved in the direction parallel to the longitudinal extension of the carrier and then reattached. However, this is time-consuming and inconvenient for the user. Another disadvantage is that with such guide arrangements, no side adjustment of the movable furniture part is possible.

### SUMMARY OF THE INVENTION

The object of the present invention is to specify a guide arrangement which is improved compared to the prior art, in particular wherein a simple height adjustment is possible and/or a side adjustment of the movable furniture part is possible. Furthermore, a piece of furniture with such a guide device is also to be specified.

In a guide arrangement according to the invention, the height adjustment device forms an inclined surface, preferably at least one wedge, for adjusting the at least two hinges relative to the at least one guide system in the direction parallel to the longitudinal extension of the carrier.

A side adjustment device for adjusting the at least two hinges relative to the at least one guide system in a direction orthogonal to the longitudinal extension of the carrier is also provided, and the height adjustment device and the side adjustment device form a common structural unit. Height adjustment can be implemented in a simple manner via an inclined surface. In particular, this also allows for the creation of a central setting option, so that a user only needs to make a height adjustment in one place.

The side adjustment device thus allows for side adjustment of the movable part of the furniture relative to the stationary part of the furniture. Because the height adjustment device and the side adjustment device form a single common structural unit, a small space requirement and user-friendly operation of the adjustment devices can be ensured.

With regard to a piece of furniture according to the invention, the piece of furniture comprises at least one stationary furniture part, in particular a furniture wall, and at least one movable furniture part, in particular a sliding door or folding-sliding door, and a guide arrangement according to the invention for guiding the at least one movable furniture part on the stationary furniture part. Preferably, the at least one stationary furniture part at least partially delimits a shaft-like cavity of the piece of furniture in which the at least one movable furniture part can be arranged.

The at least two hinges can be adjusted in the direction parallel to a longitudinal extension of the carrier independently of an adjustment in the direction orthogonal to the longitudinal extension of the carrier and/or wherein the at least two hinges can be adjusted in the direction orthogonal to the longitudinal extension of the carrier independently of an adjustment in the direction parallel to the longitudinal extension of the carrier. This makes it possible to perform a height adjustment independently of a side adjustment and vice versa. This enables a more precise adjustment of the movable furniture part.

The carrier can also be enclosed at least in sections (partially) by the guide device.

Preferably, the carrier has two end regions, wherein a side adjustment device is arranged in each of the two end regions, and the at least one height adjustment device is arranged in at least one, preferably exactly one, of the at least two end regions. This can ensure that sufficient adjustment possibilities are present. Particularly when only exactly one height adjustment device is provided, an ideal ratio between adjustment possibilities and the required effort is achieved.

Particularly preferably, at least two guide systems are provided, and preferably the at least two guide systems are to be arranged on the stationary furniture part parallel to one another and/or spaced apart from one another in the direction parallel to the longitudinal extension of the carrier. This enables a more stable guidance of the carrier on the stationary furniture part.

In one exemplary embodiment, the guide arrangement has a first actuating element for actuating the height adjustment device. Preferably, the first actuating element, even when the movable furniture part is fastened to the carrier, is accessible, and further preferably the first actuating element is aligned:
parallel to the direction orthogonal to the longitudinal extension of the carrier, or
obliquely, preferably at an angle of 45°, to the direction orthogonal to the longitudinal extension of the carrier, or
orthogonal to the direction orthogonal to the longitudinal extension of the carrier.

Simple height adjustment is possible via the first actuating element. The different orientations of the first actuating element ensure, depending on the furniture construction, that the first actuating element remains accessible even when the movable furniture part is attached to the carrier. Thus, a height adjustment is possible on a fully assembled piece of furniture.

In a further preferred embodiment, the guide arrangement comprises:
a compensation device for compensating for a tilting moment of the carrier or of the at least one movable furniture part arranged thereon about a tilting axis by means of a restoring moment, wherein the compensation device comprises at least one cable pull device with at least one cable,
at least one deflection roller connected to the guide device in a movement-coupled manner for deflecting the at least one cable, and
an inclination adjustment device for adjusting an inclination of the movable furniture part.

Via the inclination adjustment device, the carrier is movable relative to the at least one deflection roller, preferably in a direction orthogonal to a longitudinal extension of the carrier, and/or the inclination adjustment device comprises at least one fastening device for fastening the at least one cable. The at least one fastening device is displaceable relative to the carrier, preferably in a direction parallel to the longitudinal extension of the carrier.

Via the compensation device, tilting moments acting on the carrier, for example due to the dead weight of the movable furniture part or due to a blockage of the carrier or movable furniture part when the movable furniture part moves out of the cavity, can be compensated. A cable pull device represents a simple implementation of such a compensation device.

The inclination adjustment device enables an inclination adjustment of the movable furniture part. The inclination adjustment device can likewise have a small space requirement.

### BRIEF DESCRIPTION OF THE DRAWINGS

Further details and advantages of the invention will be explained in more detail below with reference to the drawings, in which:

FIGS. 1a, 1b are schematic, perspective views of two embodiments of furniture according to the invention,

FIGS. 2a-2h are schematic representations of various adjustments of the furniture according to FIG. 1a,

FIG. 3a shows a part of the furniture according to FIG. 1b,

FIG. 3b shows an embodiment of a guide arrangement,

FIGS. 4a-4c are various views of an embodiment of a height adjustment device,

FIG. 5 shows the height adjustment device according to FIGS. 4a-4c during adjustment,

FIGS. 6a-6c are various views of an embodiment of a side adjustment device,

FIG. 7 shows the side adjustment device according to FIGS. 6a-6c during adjustment,

FIGS. 8a, 8b are various views of a further embodiment of the side adjustment device,

FIGS. 9a, 9b are various views of an embodiment of an inclination adjustment device,

FIG. 10 is a perspective view of a further embodiment of the guide arrangement,

FIGS. 11a-11d are various views of an embodiment of a compensation device,

FIGS. 12a-12c are perspective views of guide devices of the guide arrangement according to FIG. 10,

FIGS. 13a, 13b show a further embodiment of the height adjustment device,

FIGS. 14a, 14b are various views of a further embodiment of the side adjustment device,

FIG. 15 shows a further embodiment of the inclination adjustment device,

FIGS. 16a-16c are various views of a further embodiment of the inclination adjustment device,

FIGS. 17a, 17b are various views of an embodiment of a depth adjustment device,

FIG. 18 is a perspective view of a part of a further embodiment of the guide arrangement,

FIGS. 19a-19d are various views of an embodiment of a combined height and side adjustment device, and

FIGS. 20a-20d are various views of a further embodiment of the side adjustment device.

### DETAILED DESCRIPTION OF THE INVENTION

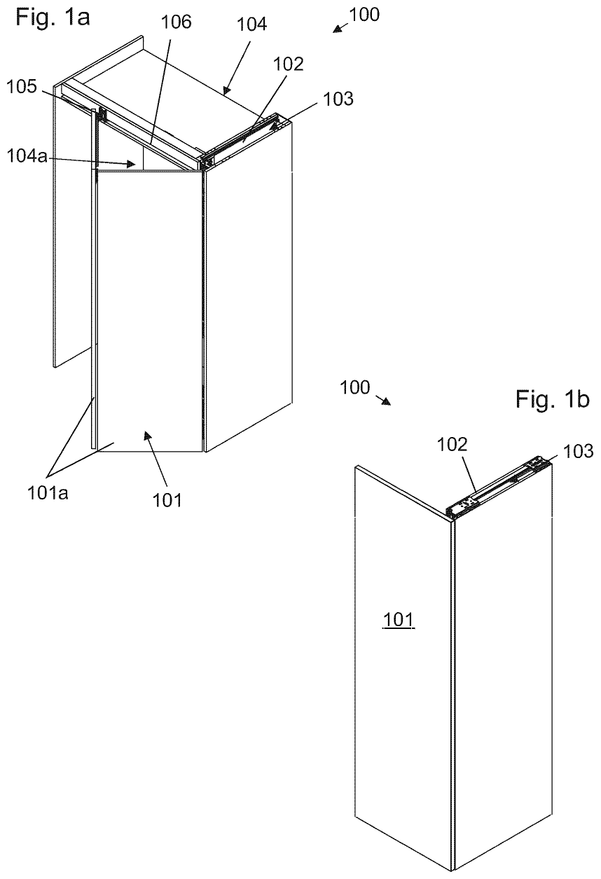

FIG. 1a shows a piece of furniture 100 in a perspective view. The furniture 100 consists of a furniture carcass 104 which has an interior 104a. A stationary furniture part 102 is designed here as a furniture wall and is part of the furniture carcass 104. In addition, the stationary furniture part 102 also delimits a cavity 103 of the furniture 100, in which a movable furniture part 101 can be arranged.

In this embodiment, the movable furniture part 101 is designed as a folding-sliding door. The folding-sliding door comprises two door leaves 101a which are connected to one another in an articulated manner. One of the door leaves 101a is fastened pivotably to a carrier 5 of a guide arrangement 1, while the other door leaf 101a is connected to a carriage 105. The carriage 105 is displaceably mounted on a rail 106 and guides the movable furniture part 101 along the rail 106. In a closed position, the interior 104a can be covered by means of the folding-sliding door. In this position, the door leaves 101a lie substantially in one plane.

When transferring the furniture 100 into an open position, the two door leaves 101a are pivoted toward one another until they are arranged substantially parallel to one another. In the process, the free door leaf 101a, which is not fastened to the carrier 5, is guided by the carriage 105 along the rail 106. Finally, the folded folding-sliding door can be moved into the cavity 103. In the process, the carriage 106 can also move into the cavity.

FIG. 1b shows a further embodiment of furniture 100. In this case, the complete furniture carcass 104 is not shown. The stationary furniture part 102 is again designed as a furniture wall and delimits a cavity 103. In this embodiment, the movable furniture part 101 is designed as a pivot-sliding door. The furniture 100 can thus be opened or closed by simply pivoting the pivot-sliding door. In the open position, the pivot-sliding door can then again be moved into the cavity 103.

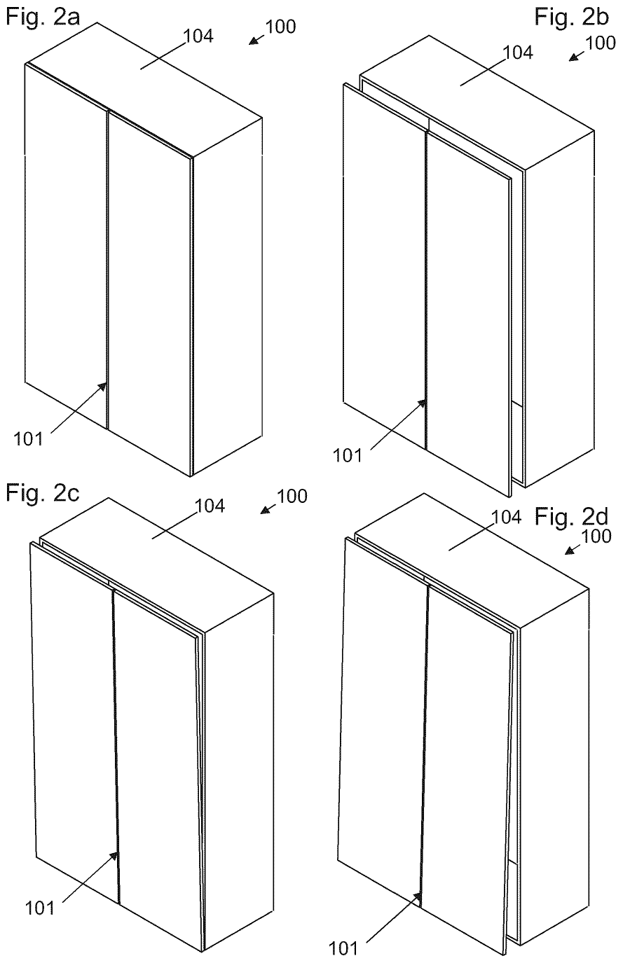

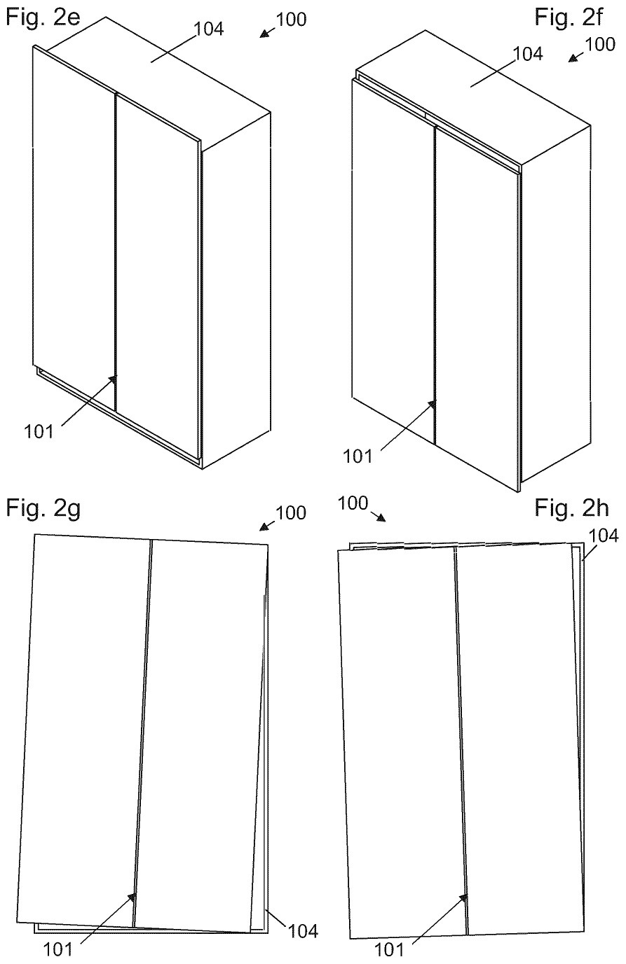

FIGS. 2a to 2h show schematic representations of various adjustments of the furniture 100. Based on these figures, it shall be explained how the movable furniture part 101 is adjustable relative to the furniture carcass 104 via a height, side, inclination, and depth adjustment device. In these figures, the furniture 100 according to FIG. 1a is shown, however, the same adjustment possibilities also exist for furniture 100 according to FIG. 1b.

In FIG. 2a, the furniture 100 is shown with an ideally adjusted folding-sliding door. In FIG. 2b, the distance between the movable furniture part 101 and the furniture carcass 104 is too large. This distance can be adjusted via the depth adjustment device 33.

In FIG. 2c, the folding-sliding door is inclined relative to the furniture carcass 104, specifically the distance of the folding-sliding door is greater in an upper region than in a lower region. In FIG. 2d as well, the folding-sliding door is inclined relative to the furniture carcass 104, specifically exactly the opposite of FIG. 2c. This inclination of the movable furniture part 101 relative to the furniture carcass 104 can be adjusted via the inclination adjustment device 20.

In FIG. 2e, the movable furniture part 101 is adjusted too high, and in FIG. 2f too low. This height adjustment can be implemented via the height adjustment device 7.

In FIG. 2g, the folding-sliding door is twisted relative to the furniture carcass 104. This is due to the folding-sliding door not being flush with the furniture carcass 104 in a lower region. This can be corrected by adjusting a lower side adjustment device 8. In FIG. 2h, an upper side adjustment device 8 is incorrectly adjusted.

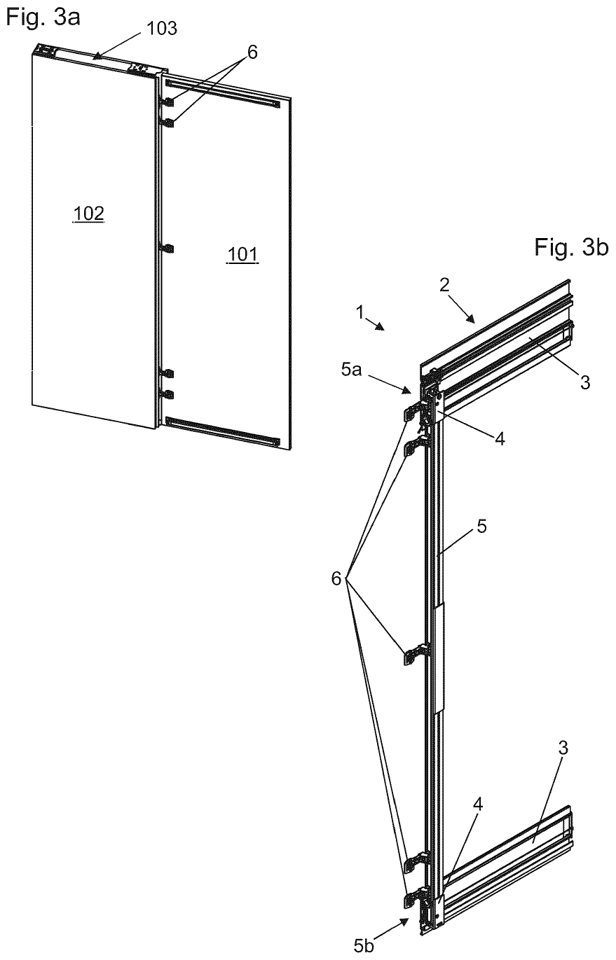

FIG. 3a shows a part of the furniture 100 according to FIG. 1b, wherein the pivot-sliding door is already opened but not yet moved into the cavity 103. A guide arrangement 1 is arranged on the stationary furniture part 102. In FIG. 3b, an embodiment of such a guide arrangement 1 is shown. The guide arrangement 1 has two guide systems 2. The guide systems 2 each comprise a guide 3 and a guide device 4. The guide devices 4 are displaceably mounted on their respective guide 3.

The guides 3 are arranged on the stationary furniture part 102. In this embodiment, the guides 3 are aligned parallel to one another and are spaced apart from one another in the direction of a longitudinal extension L of a carrier 5.

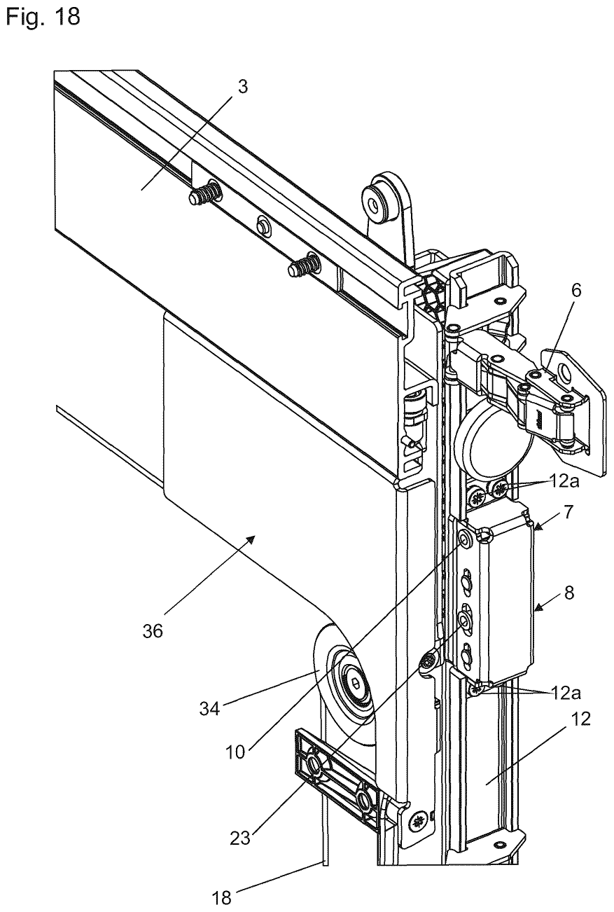

The carrier 5 is connected to the guide devices 4 in a movement-coupled manner. Hinges 6 are arranged on the carrier 5, via which the folding-sliding door is pivotably mounted on the carrier 5. The hinges 6 can be arranged directly on the carrier 5. Alternatively, it is also conceivable that the hinges 6 are arranged on a holding element 12 (see FIG. 18). The carrier 5 has two end regions 5a, 5b. In this embodiment, a height adjustment device 7 and a side adjustment device 8 are provided in an upper end region 5a. Only one side adjustment device 8 is arranged in a lower end region 5b.

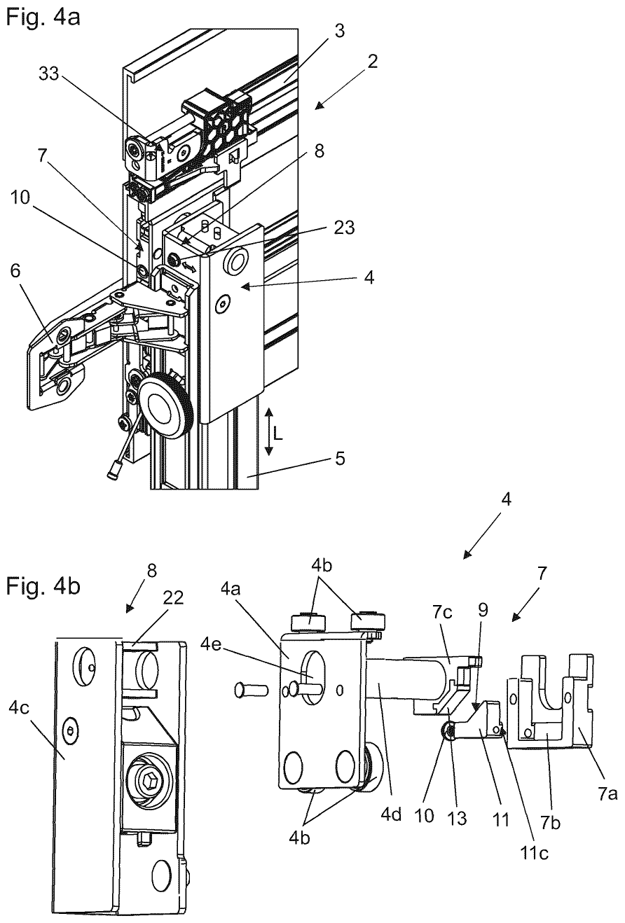

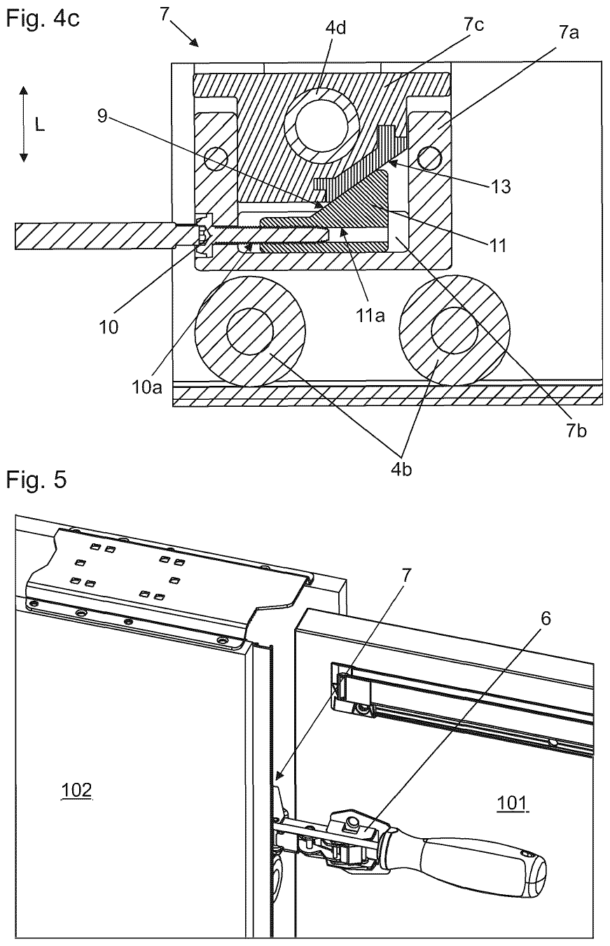

FIGS. 4a to 4c show various views of an embodiment of a height adjustment device 7. In FIG. 4a, the upper guide device 4 can be seen in an installed state. The guide device 4 encloses the carrier 5 at least in regions. Both a height adjustment device 7 and a side adjustment device 8 are integrated into the guide device 4. In principle, the height adjustment device 7 and the side adjustment device 8 could also be arranged outside the guide device 4. A first actuating element 10 is provided for actuating the height adjustment device 7, and a second actuating element 23 is provided for actuating the side adjustment device 8. A depth adjustment device 33 can also be seen on the guide 3. The depth adjustment device 33 can be designed according to the prior art. The depth can be adjusted according to FIG. 2b via the depth adjustment device 33.

In the exploded view of FIG. 4b, it can be seen that the guide device 4 comprises a carriage 4a with several rotatably mounted rollers 4b. The rollers 4b are supported on the guide 3, whereby the guide device 4 can be displaceably mounted on the guide 3. The guide device 4 further comprises a connecting element 4c for connecting the carrier 5 to the guide device 4. For this purpose, the connecting element 4 is connected on one side to the carrier 5 and encloses the latter in regions. On the other hand, the connecting element 4c is displaceably mounted on a bearing pin 4d.

The bearing pin 4d is guided through an opening 4e in the carriage 4a. The opening 4e is dimensioned such that the bearing pin 4d has play at least in a vertical direction. In this embodiment, the side adjustment device 8 is arranged substantially within the connecting element.

The height adjustment device 7 comprises a base body 7a. A height adjustment element 11 is displaceably mounted in the base body 7a. For this purpose, a groove 7b is provided in the base body 7a, in which a projection 11c is guided. The height adjustment element 11 has a inclined surface 9 and a counter-thread 11a. A thread 10a of the first actuating element 10 is in engagement with the counter-thread 11a. In this embodiment, the first actuating element 10 is designed as a screw. Other designs are also conceivable.

Furthermore, a bearing element 7c is provided, which is displaceably mounted in the base body 7a. The bearing element 7c has a further inclined surface 13, which comes to bear against the inclined surface 9.

The further inclined surface 13 is formed from a friction-reducing material, for example a special plastic. However, it can also be provided that the further inclined surface 13 is merely coated with a friction-reducing material. The bearing element 7c is further connected to the bearing pin 4d in a movement-coupled manner.

FIG. 4c shows a section through the height adjustment device 7. The direction of the longitudinal extension L of the carrier 5 is likewise shown as a reference. It can be seen that the height adjustment element 11 is mounted displaceably in a further direction orthogonal to the longitudinal extension L of the support. The first actuating element 10 is in engagement with the counter-thread 11a of the height adjustment element 11 via the thread 10a.

An actuation—in this case, a rotation—of the first actuating element 10 consequently results in a movement of the height adjustment element 11 in the further direction orthogonal to the longitudinal extension L of the carrier 5.

The further inclined surface 13 bears against the inclined surface 9; a displacement of the height adjustment element 11 therefore also leads to a displacement of the inclined surfaces 9, 13 relative to one another. As a result, the bearing element 7c is moved in a direction parallel to the longitudinal extension L. Since the bearing element is connected to the carrier 5 via the bearing pin 4d and the connecting element 4c, the carrier 5, and thus also the hinges 6 and the movable furniture part 101, can thereby likewise be moved in the direction parallel to the longitudinal extension L. This corresponds to a height adjustment according to FIGS. 2e and 2f.

FIG. 5 shows the height adjustment device 7 in an installed state. In this case, the first actuating element 10 is actuated via a screwdriver. It can be seen that the first actuating element 10 remains accessible even in a mounted state of the furniture 100. Thus, a movable furniture part 101 does not first have to be removed before the height adjustment device 7 can be actuated.

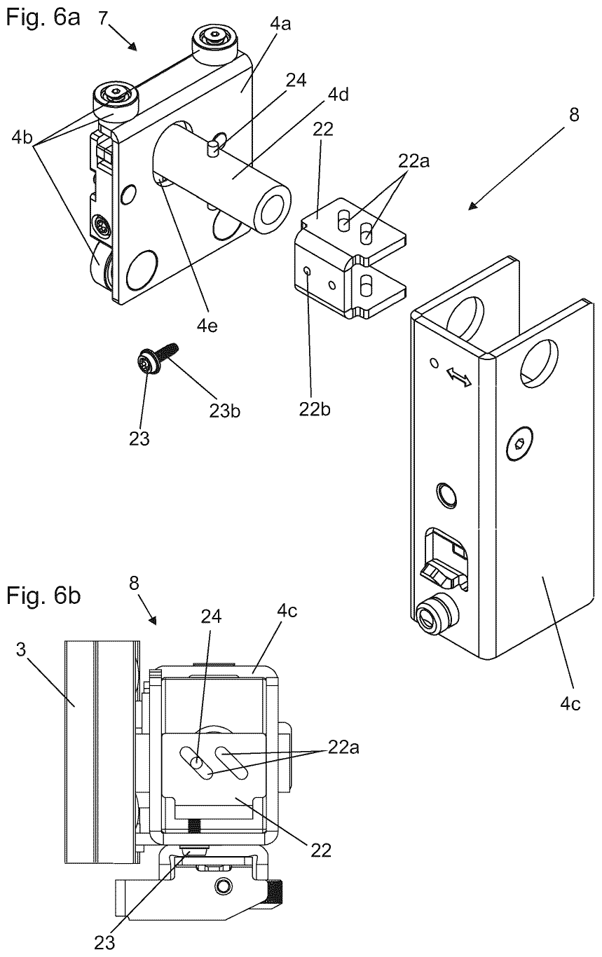

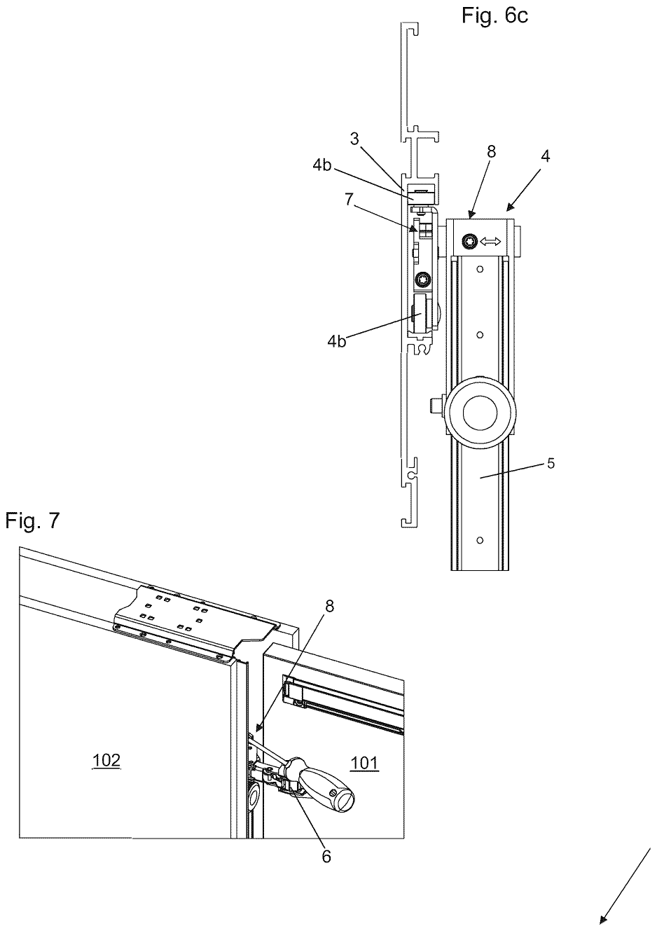

FIGS. 6a to 6c show various views of an embodiment of the side adjustment device 8. A side adjustment element 22 at least partially encloses the bearing pin 4d in an installed state (FIG. 6b). The side adjustment element 22 furthermore has guide slots 22a. The guide slots 22a are designed as elongated holes and are aligned at an angle of approx. 45° to the direction orthogonal to the longitudinal extension L of the support. In addition, a counter-thread 22b is also provided in the side adjustment element 22, wherein the second actuating element 23 is in engagement with the counter-thread 22b. For this purpose, a thread 23b is provided on the second actuating element 23. A guide pin 24, which is guided in one of the guide slots 22a, is arranged on the bearing pin 4d.

By actuating—in this case, rotating—the second actuating element 23, the side adjustment element 22 can be moved in the further direction orthogonal to the longitudinal extension L. Since the side adjustment element 22 is guided in the connecting element 4c and the guide pin 24 is guided in the guide slot 22a, a movement of the side adjustment element 22 in the further direction orthogonal to the longitudinal extension L of the carrier 5 results in a movement of the connecting element 4c, and accordingly of the carrier 5, the hinges 6, and the movable furniture part 101, in the direction orthogonal to the longitudinal extension L of the support. The direction orthogonal to the longitudinal extension L of the carrier 5 and the further direction orthogonal to the longitudinal extension L of the carrier 5 are arranged at right angles to one another in this embodiment.

FIG. 6c also shows how the guide device 4 is mounted on the guide 3.

In FIG. 7, the side adjustment device 8 is shown in an installed state. It can also be seen here that the second actuating element 23 of the side adjustment device 8 can be actuated via a screwdriver in an installed state.

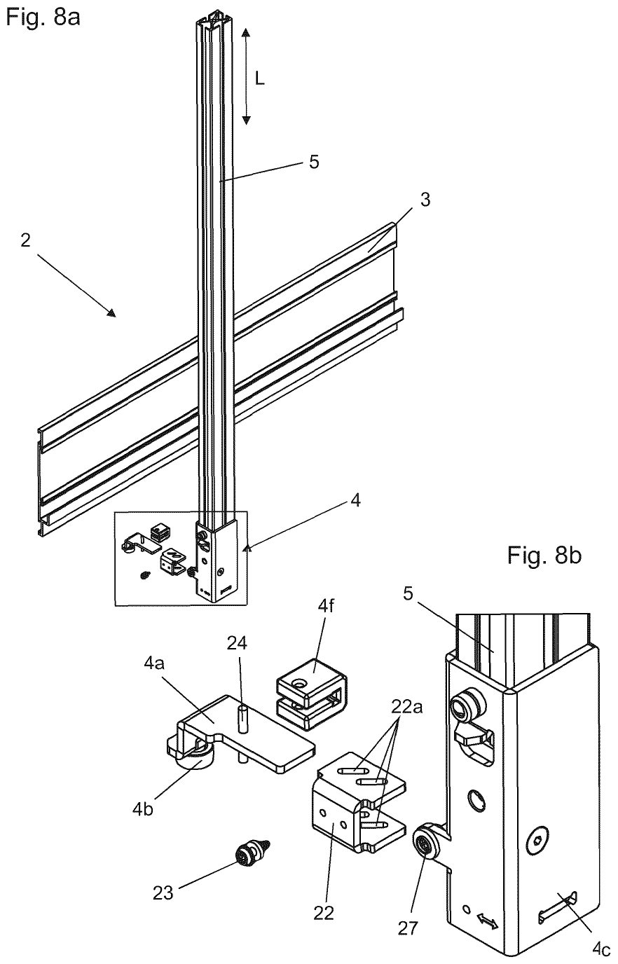

FIGS. 8a and 8b show various views of a further embodiment of the side adjustment device 8. This embodiment relates to a lower side adjustment device 8 when two side adjustment devices 8 are provided. The basic functional principle of the side adjustment device 8 is the same as in the side adjustment device 8 according to FIGS. 6a to 6c. A side adjustment element 22 is thus again provided, which has guide slots 22a in which the guide pin 24 is guided. The side adjustment element 22 is movable by actuating the second actuating element 23, which effects a movement of the carrier 5. The present embodiment differs in that the guide pin 24 is now arranged directly on the carriage 4a of the guide device 4. In addition, a support element 4f is also provided, which serves to provide sufficient guidance and support for the side adjustment element 22.

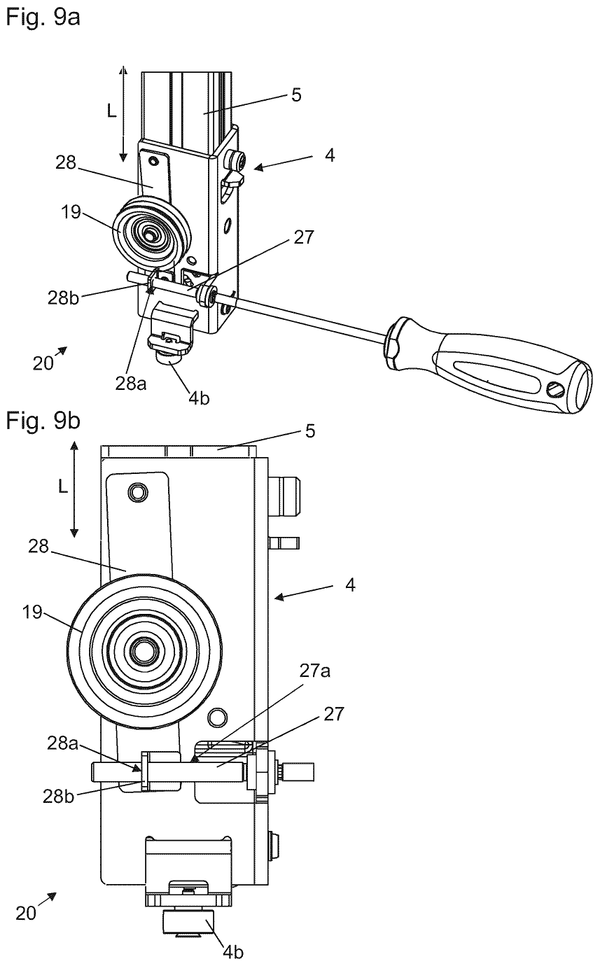

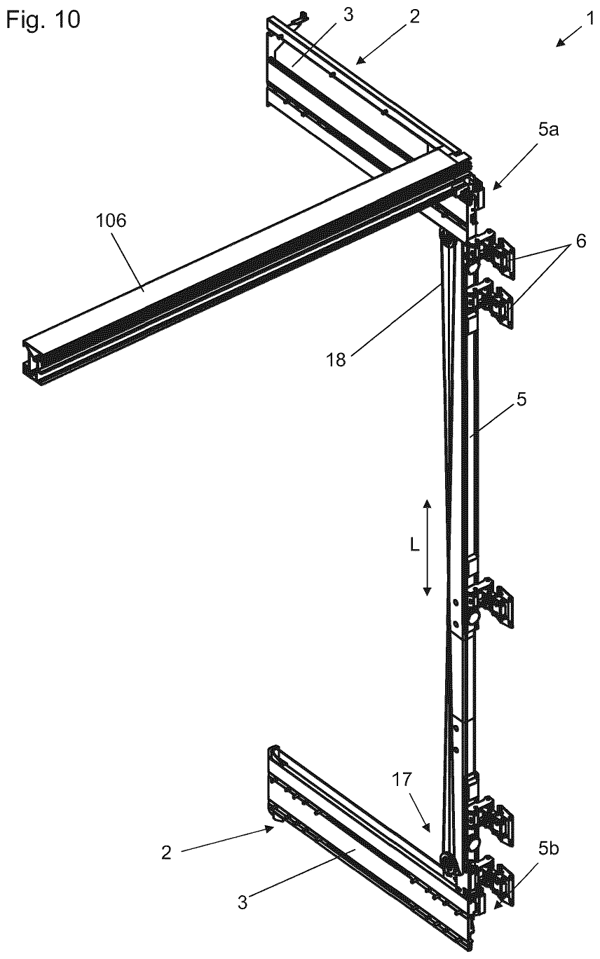

FIGS. 9a and 9b show various views of an embodiment of an inclination adjustment device 20. In this embodiment, the inclination adjustment device 20 is arranged in a lower end region 5b of the carrier 5. The inclination adjustment device 20 comprises a swivel element 28 which is pivotably arranged on the guide device 4. A deflection roller 19 of the compensation device 17 is arranged on the swivel element 28. This deflection roller 19 is wrapped by the cable 18 (not shown). The deflection roller 19, and thus also the swivel element 28, are thereby fixed relative to the compensation device 17 and thus also to the guide system 2.

In addition, a bracket 28b is rotatably mounted on the swivel element 28. The bracket 28b has a counter-thread 28a.

A third actuating element 27 is rotatably mounted on the guide device 4. The third actuating element 27 has a thread 27a which is in engagement with the counter-thread 28a on the swivel element 28. In this case, the actuating element 28 is designed as a screw. Since the deflection roller 19, and thus the swivel element 28, are fixed relative to the guide system 2 via the cable 18, an actuation of the third actuating element 27 results in a movement of the carrier 5 relative to the deflection roller 19 and thus relative to the guide system 2. The inclination according to FIGS. 2c and 2d can therefore be adjusted via the inclination adjustment device 20.

FIG. 10 shows a perspective view of a further embodiment of the guide arrangement 1. Such a guide arrangement 1 is used for furniture 100 according to FIG. 1a. The guide arrangement 1 again has two guide systems 2. The guide systems 2 each comprise a guide 3 and a guide device 4. The guide devices 4 are displaceably mounted on their respective guide 3. The guides 3 are arranged on the stationary furniture part 102. In this embodiment, the guides 3 are aligned parallel to one another and are spaced apart from one another in the direction of a longitudinal extension L of a carrier 5.

The carrier 5 is connected to the guide devices 4 in a movement-coupled manner. Hinges 6 are arranged on the carrier 5, via which the folding-sliding door is pivotably mounted on the carrier 5. The hinges 6 are arranged directly on the carrier 5. Alternatively, it is also conceivable that the hinges 6 are arranged on a holding element 12 (see FIG. 18).

The carrier 5 has two end regions 5a, 5b, and in this embodiment only one height adjustment device 7 is provided in an upper end region 5a. A height adjustment device 7, a side adjustment device 8, and an inclination adjustment device 20 are arranged in a lower end region 5b. In addition, a rail 106 can also be seen, on which a carriage 105 can be displaceably mounted. A compensation device 17 is also partially visible. The compensation device 17 is designed as a cable pull device.

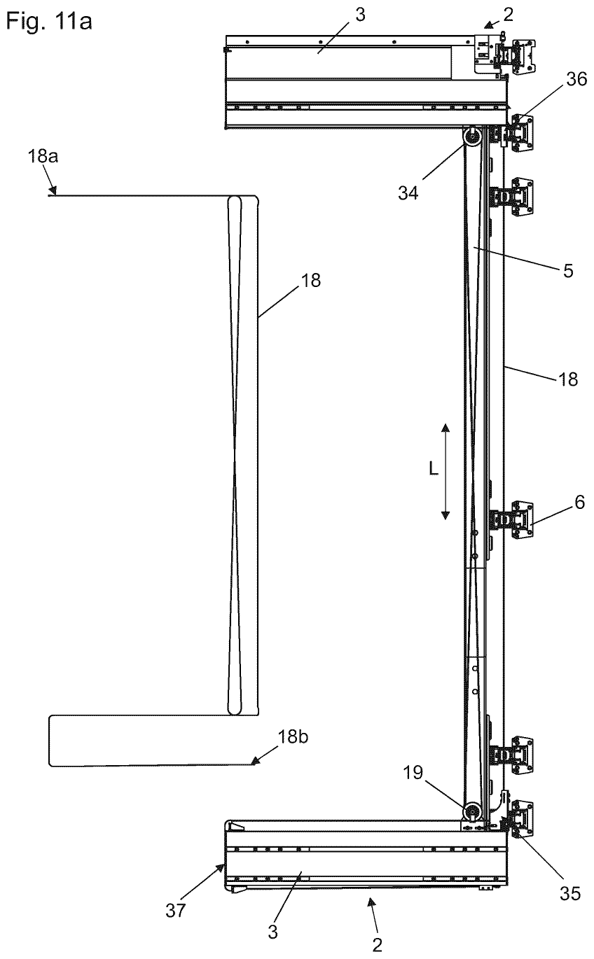

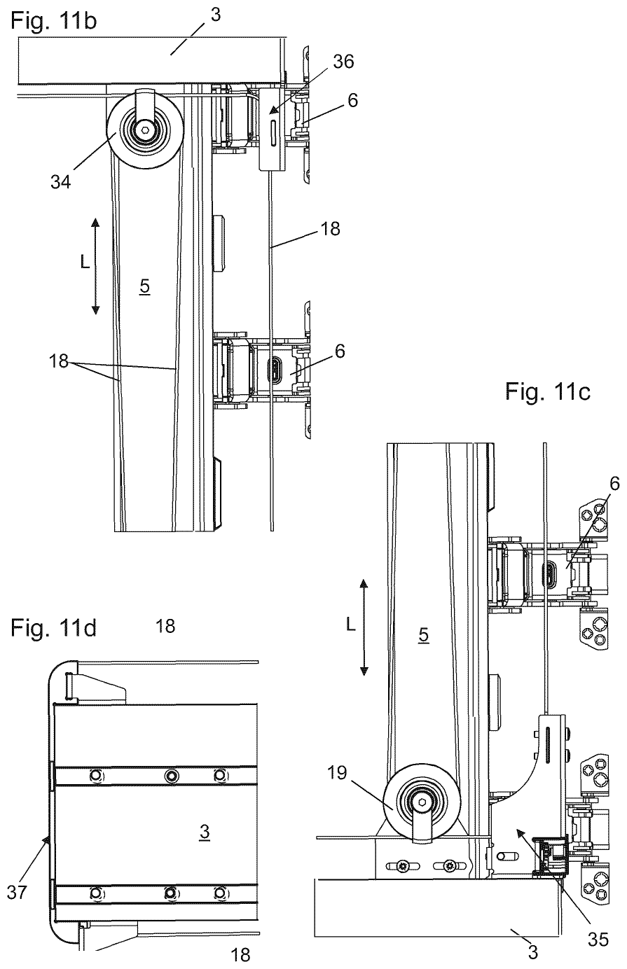

FIGS. 11a to 11d show various views of an embodiment of a compensation device 17. In this figure, a cable 18 of the cable pull device and its course are also shown separately once again. The cable 18 is arranged with a first end 18a at one of the two guides 3 and with a second end 18b at the other of the two guides 3. The effective length of the cable 18 is therefore constant. Starting from the first end 18a, the cable 18 is guided to an upper deflection roller 34. The upper deflection roller 34 is connected to the upper guide device 4 and/or the carrier 5 in a movement-coupled manner.

From the upper deflection roller 34, the cable 18 is guided to the deflection roller 19, which deflects the cable 18 in the direction of the hinges 6. The cable 18 is then deflected again by a lower deflection device 35 and guided upward along the carrier 5 parallel to the longitudinal extension L. After a further deflection of the cable 18 by an upper deflection device 36 to the upper deflection roller 34, the cable 18 is guided from the upper deflection roller 34 back to the deflection roller 19. From there, the cable 18 runs along the lower guide 3, is deflected around the guide 3 by means of the rear deflection device 37, and is then fastened to the guide 3 in the front region thereof. A tilting moment at the carrier 5, for example when the folding-sliding door is open, can be absorbed by the cable 18 and thus be compensated for.

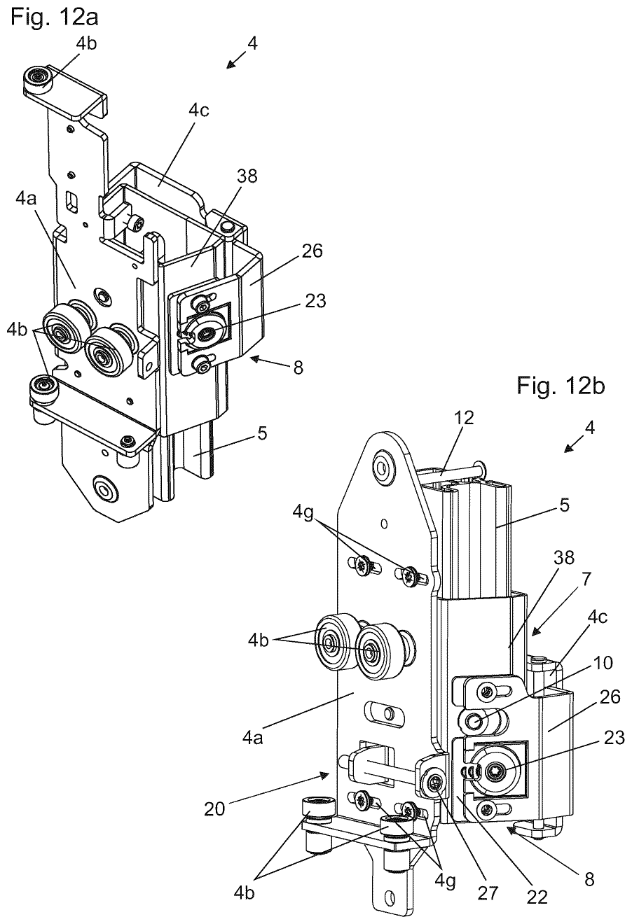

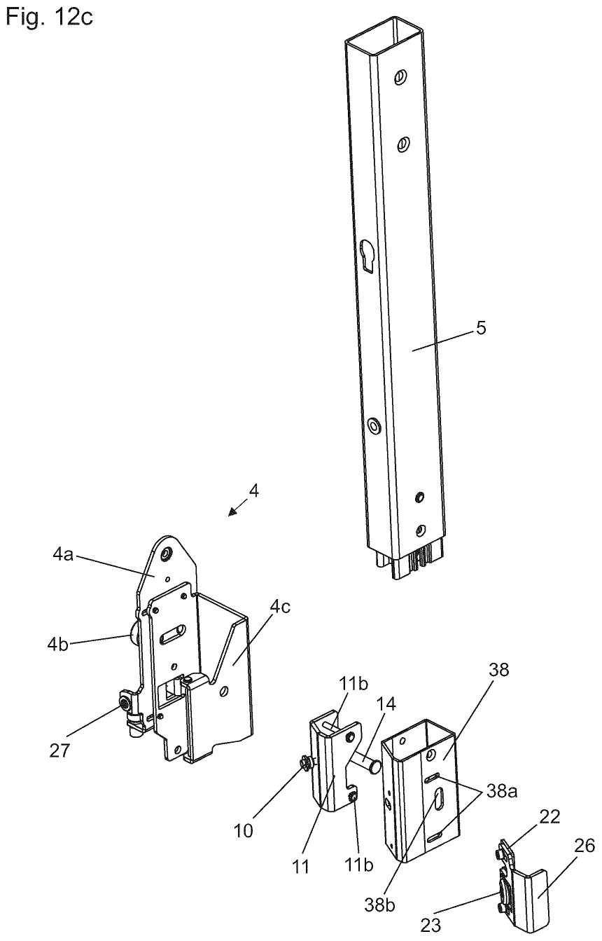

FIGS. 12a to 12c show perspective views of guide devices 4 of a guide arrangement 1 according to FIG. 10. In FIG. 12a, a guide device 4 of an upper guide system 2 is shown, in FIG. 12b, a guide device 4 of a lower guide system 2 is shown, and in FIG. 12c, an exploded view of a guide device 4 of a lower guide system 2 is shown. The guide devices 4 comprise several rollers 4b which can travel on the respective guides 3. The rollers 4b are rotatably mounted on a respective carriage 4a. The carriage 4a is connected to a connecting element 4c, which in turn is connected to the carrier 5.

It can again be seen that the carrier 5 is at least in regions enclosed by the guide devices 4, in particular by the connecting element 4c. The guide device 4 in FIG. 12a has a side adjustment device 8, while the guide device in FIG. 12b has a side adjustment device 8, a height adjustment device 7, and an inclination adjustment device 20.

Correspondingly, the first actuating element 10, the second actuating element 23, and the third actuating element 27 can also be seen. The actuating elements 10, 23, 27 are oriented obliquely to a direction orthogonal to the longitudinal extension L of the carrier 5. As a result, the actuating elements 10, 23, 27 remain accessible even when the furniture 100 is fully assembled.

In FIG. 12c, a height adjustment element 11 and an abutment element 14 of the height adjustment device 7 can additionally be seen. The height adjustment element 11 is displaceably mounted in first elongated holes 38a of a transition element 38 by means of the connecting pins 11b. A bearing element 26, a side adjustment element 22, and a second actuating element 23 of the side adjustment device 8 are also shown.

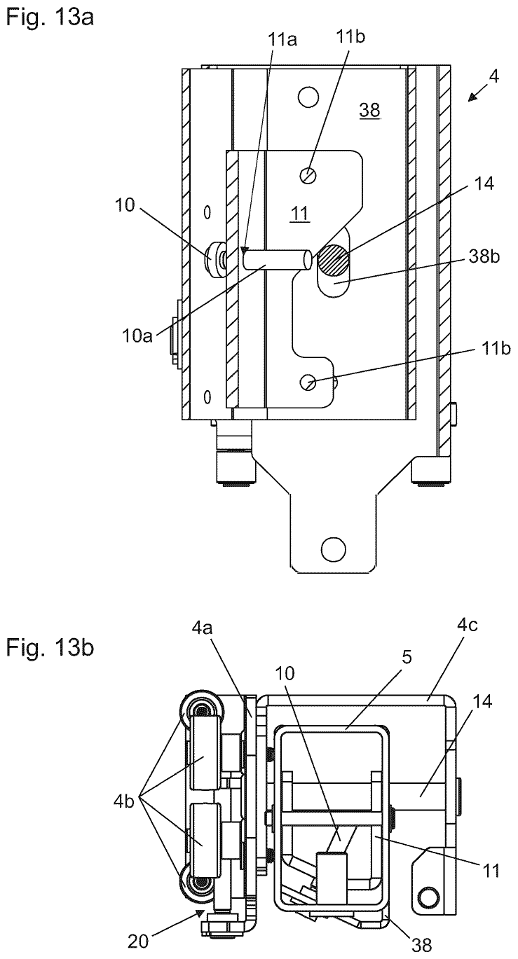

FIGS. 13a and 13b show a further embodiment of the height adjustment device 7. The height adjustment element 11 has a inclined surface 9 which comes to bear against an abutment element 14. The abutment element 14 is connected to the guide device 4 and reaches through the second elongated holes 38b of the transition element 38. As already stated, the height adjustment element 11 is movably mounted in the transition element 38. The carrier 5 is thus supported via the transition element 38 and the height adjustment element 11 on the abutment element 14.

The first actuating element 10 is rotatably mounted in the transition element 38 and, with its thread 10a, is in engagement with a counter-thread 11a on the height adjustment element 11. By actuating—in this case, rotating—the first actuating element 10, the height adjustment element 11 is moved in the further direction orthogonal to the longitudinal extension L of the carrier 5. The carrier 5 is thereby raised or lowered via the inclined surface 9.

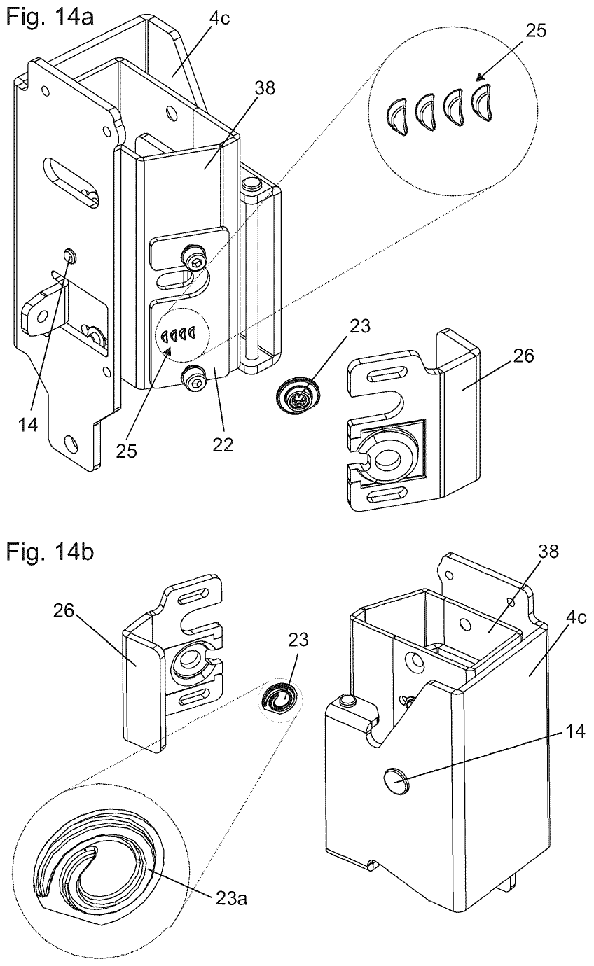

FIGS. 14a and 14b show various views of a further embodiment of the side adjustment device 8. FIG. 14a shows the side adjustment device 8 for the guide device 4 of the upper guide system 2, and FIG. 14b shows it for the guide device 4 of the lower guide system 2. The transition element 38 is displaceably mounted on the connecting element 4c along the abutment element 14 in the direction orthogonal to the longitudinal extension L of the carrier 5.

In this embodiment, the side adjustment element 22 is arranged on the transition element 38 and has a toothing 25. The toothing 25 consists of a row of substantially crescent-shaped projections. The second actuating element 23 is rotatably mounted on a bearing element 26 and has a spiral-shaped projection 23a on one side. In an assembled state, the spiral-shaped projection 23a is in engagement with the toothing 25. By actuating—in this case, rotating—the actuating element 23, the transition element 38 and thus the carrier 5 are moved in the direction parallel to the longitudinal extension L of the carrier 5.

So that no movement of the carrier 5 in the further direction orthogonal to the longitudinal extension L of the carrier 5 occurs despite the oblique arrangement of the toothing 25 and the second actuating element 23, the bearing element 26 is displaceably arranged on the guide device 4 in the further direction orthogonal to the longitudinal extension L.

In this embodiment, it would also be conceivable for the spiral-shaped projection 23a to be oval. In that case as well, rotating the second actuating element 23 would result in a movement of the carrier 5 in the direction orthogonal to the longitudinal extension L of the carrier 5. However, only a single projection on the side adjustment element 22 would then be necessary instead of toothing 25. Similarly, it would also be conceivable for the spiral-shaped projection 23a to be circular and for the second actuating element 23 to be eccentrically mounted.

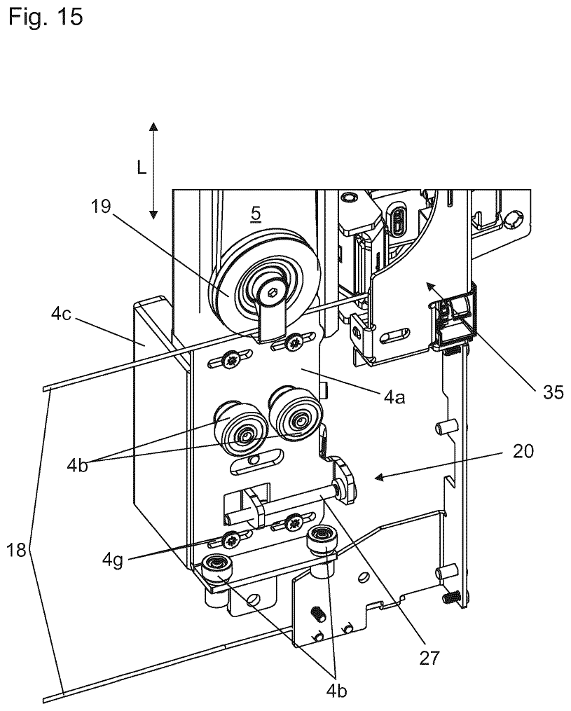

FIG. 15 shows a further embodiment of the inclination adjustment device 20. The carrier 5 is displaceably arranged on the guide device 4 in the further direction orthogonal to the longitudinal extension L of the guide 3. For this purpose, elongated holes 4g are provided on the carriage 4a of the guide device 4, in which the carrier 5 is mounted. The deflection roller 19 of the compensation device 17 is also arranged on the carriage 4a. The deflection roller 19 is again fixed relative to the stationary furniture part 102 by the cable 18. In addition, a third actuating element 27 is rotatably mounted on the carriage 4. The third actuating element 27 has a thread 27a which is in engagement with a counter-thread 5c arranged on the carrier 5.

By actuating—in this case, rotating—the third actuating element 27, the carrier 5 can be moved relative to the deflection roller 19 in the further direction orthogonal to the longitudinal extension of the carrier 5. Since only one inclination adjustment device 20 is provided, an inclination adjustment according to FIGS. 2c and 2d can take place.

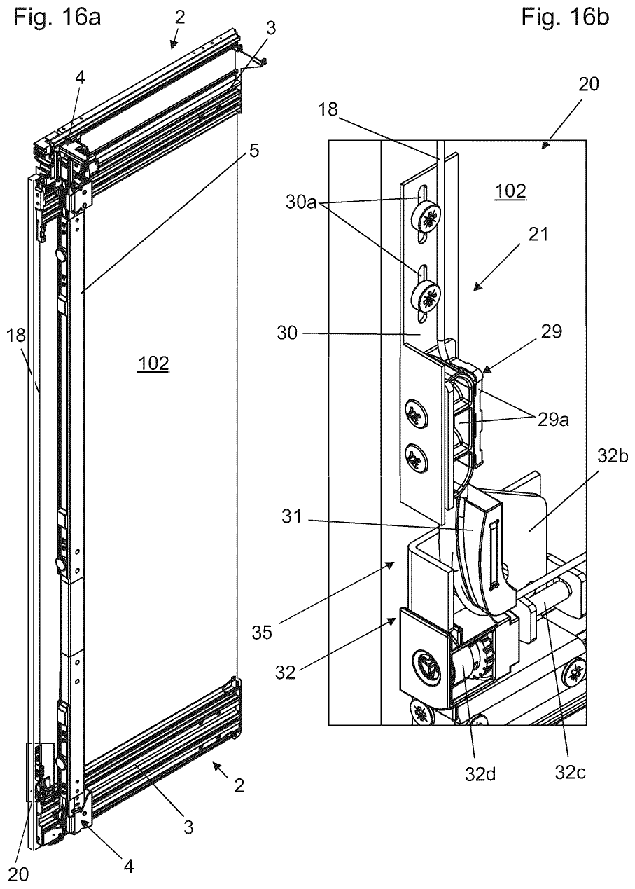

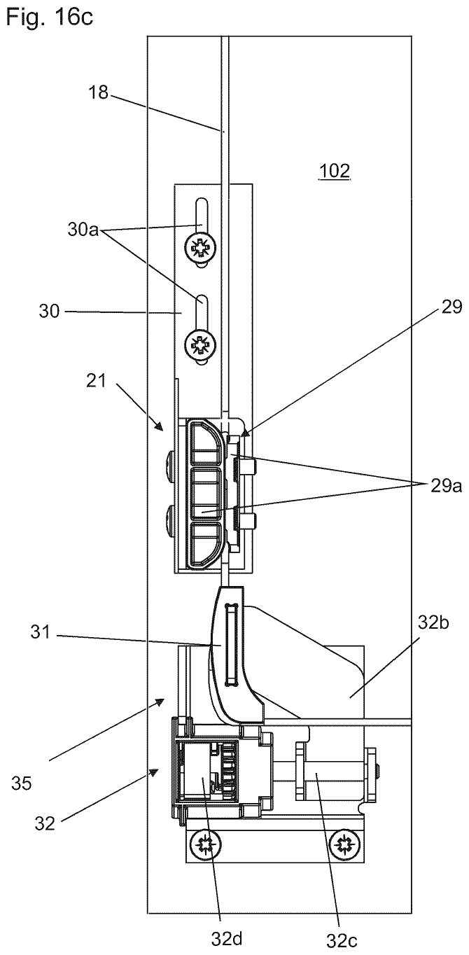

FIGS. 16a to 16c show various views of a further embodiment of the inclination adjustment device 20. In this embodiment, the inclination adjustment device 20 comprises a fastening device 21 for fastening the cable 18 to the stationary furniture part 102. The fastening device 21 has a clamping device 29 with two clamping jaws 29a. The cable 18 can be clamped between the clamping jaws 29a. The clamping device 29 is arranged on a mounting body 30, wherein the mounting body 30 is displaceably arranged on the stationary furniture part 102 in the direction parallel to the longitudinal extension L of the carrier 5. For this purpose, two elongated holes 30a are provided on the mounting body 30.

As already stated, the effective length of the cable 18 of the cable pull device 17 is constant. A displacement of the fastening device 21 along the longitudinal extension L thus changes a ratio of cable 18 before or after a specific reference point along the longitudinal extension L. In other words, for example, upon a displacement of the fastening device 21 upward, less cable 18 will be present below the reference point and more cable 18 will be present above the reference point instead. The lower end region 5b of the carrier 5 is accordingly moved backward in the further direction orthogonal to the longitudinal extension L and the upper end region 5a is moved forward, whereby the inclination of the carrier 5 and thus of the movable furniture part 101 is adjustable.

In FIGS. 16a to 16c, a deflection element 31 can also be seen, which deflects the cable 18. The deflection element 31 is part of a cable tensioning device 32. The cable tensioning device 32 comprises a base body 32a and a holding element 32b displaceably mounted on the base body 32a. The deflection element 31 is arranged on the holding element 32b.

Furthermore, the cable tensioning device 32 comprises an actuating element 32c, which can be actuated via a torque limiter 32d. The actuating element 32c is in engagement with a thread with a counter-thread on the holding element 32b. An actuation—in this case, rotation—of the actuating element 32c consequently results in a movement of the holding element and thus of the deflection element 31. In this way, the cable 18 can be tensioned or loosened.

The torque limiter 32c serves to prevent further actuation of the actuating element 32c upon reaching a predetermined torque. This predetermined torque can be selected such that a desired cable tension is reached upon reaching the predetermined torque. Thus, it can be ensured in a simple manner that the cable 18 has the correct cable tension.

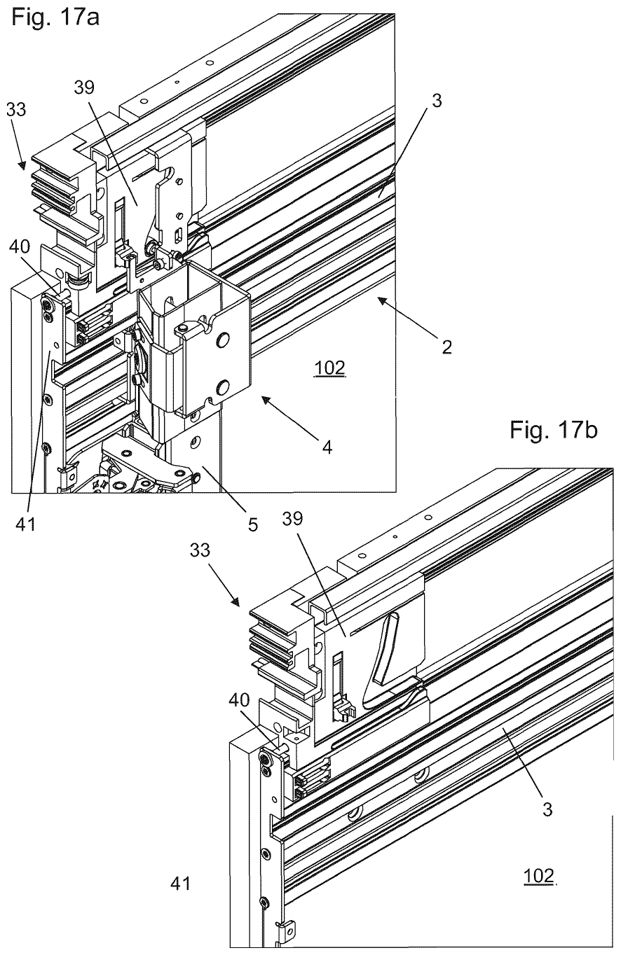

FIGS. 17a and 17b show various views of a further embodiment of the depth adjustment device 33. The depth adjustment device 33 comprises a depth adjustment element 39. The depth adjustment element 39 is displaceably mounted in the further direction orthogonal to the longitudinal extension L of the carrier 5.

A fourth actuating element 40 for actuating the depth adjustment device 33 is designed substantially in the form of a screw. The fourth actuating element 40 is rotatably mounted on a holding body 41. The holding body 41 is connected to the guide 3. The fourth actuating element 40 is also in engagement with a thread with a counter-thread on the depth adjustment element 39. By actuating—in this case, rotating—the fourth actuating element 40, the depth adjustment element 39 can be moved in the further direction orthogonal to the longitudinal extension L of the carrier 5.

The depth adjustment element 39 represents an end stop for the upper guide body 4 and the carrier 5. An adjustment of the depth adjustment element 40 relative to the stationary furniture part 102 therefore also corresponds to an adjustment of the carrier 5 relative to the stationary furniture part 102 in a closed position of the furniture 100. Thus, a depth adjustment according to FIG. 2b is possible.

FIG. 18 shows a perspective view of a part of a further embodiment of the guide arrangement 1. The guide arrangement 1 is constructed quite similarly to a guide arrangement 1 according to FIG. 3b. However, the guide arrangement 1 according to the present embodiment differs, among other things, in that the hinges 6 are not arranged directly on the carrier 5. Rather, a holding element 12 is provided, on which the hinges 6 are arranged. The holding element 12 is displaceably arranged on the carrier 5.

In FIG. 18, a height adjustment device 7 and a side adjustment device 8 can also be seen, wherein the height adjustment device 7 and the side adjustment device 8 are designed as a structural unit.

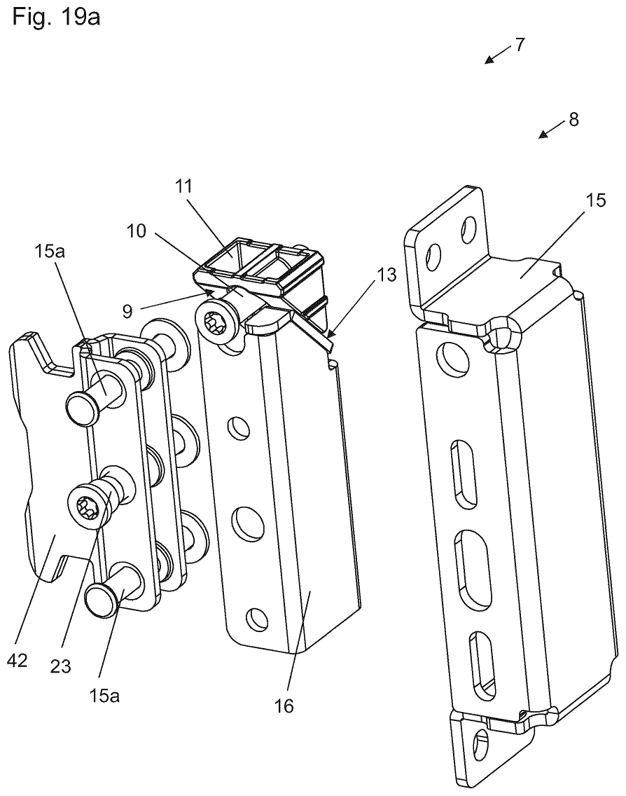

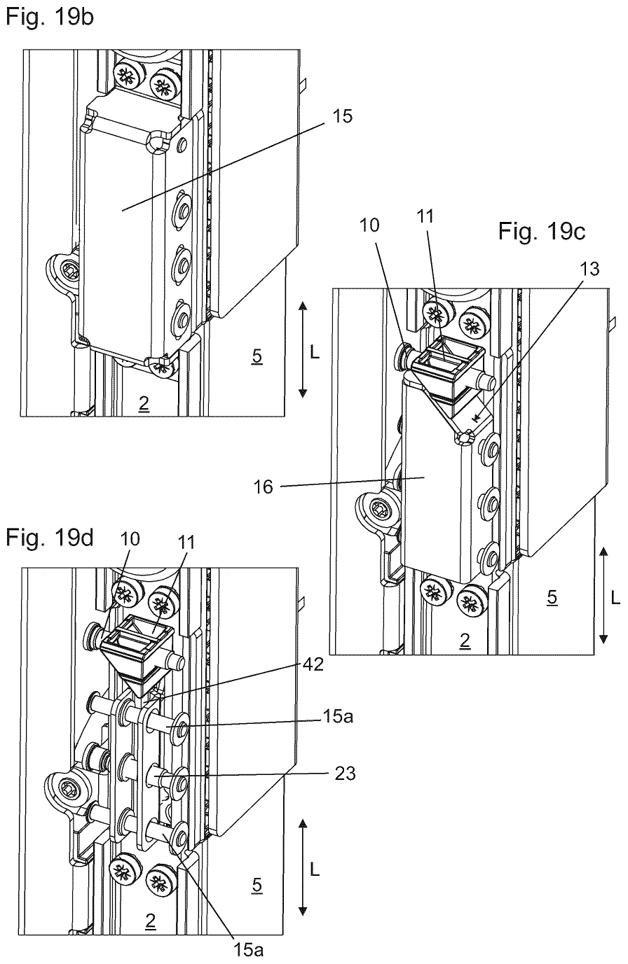

FIGS. 19a to 19d show various views of an embodiment of a combined height adjustment device 7 and side adjustment device 8. In this case, a base body 15 is provided, which is connected to the holding element 12, in this embodiment via screws 12a. Within the base body 15, an intermediate element 16 is displaceably mounted on guide pins 15a. The intermediate element 16 is connected to the carrier 5 via a connecting body 42, wherein the connecting body 42 is likewise displaceably mounted on the guide pins 15a.

A second actuating element 23 for actuating the side adjustment device 8 has a thread 8a which is in engagement with a counter-thread on the connecting body 42. In addition, the second actuating element 23 also has steps 8b, by means of which the actuating element 23 is rotatably but axially fixedly mounted on the intermediate element 16. By actuating—in this case, rotating—the second actuating element 23, the intermediate part 16, and therefore also the base body 15 and the holding element 12, can be moved relative to the connecting body 42 and thus relative to the carrier 5 in the direction orthogonal to the longitudinal extension L of the carrier 15.

The height adjustment device 7 comprises a height adjustment element 11 which has a inclined surface 9. The height adjustment element 11 is displaceably mounted on the base body 15 via a first actuating element 10. The first actuating element 10 is in engagement via a thread 10a with a counter-thread 11a of the height adjustment element 11. The intermediate element 16 has a further inclined surface 13 against which the inclined surface 9 comes to bear.

By actuating—in this case, rotating—the first actuating element 10, the height adjustment element 11 is displaced along the first actuating element 11. Via the inclined surfaces 9, 13, a movement of the height adjustment element 11 along the direction parallel to the longitudinal extension L of the carrier 5 relative to the intermediate element 16 takes place simultaneously. Accordingly, a movement of the base body 15, and thus of the holding element 12, in the direction parallel to the longitudinal extension L of the carrier 5 relative to the connecting body 42 and thus relative to the carrier 5 also takes place. Via the height adjustment device 7, the holding element 12, and thus the hinges 6 and the movable furniture part 101, is therefore adjustable relative to the stationary furniture part 102 in the direction parallel to the longitudinal extension L of the carrier 5.

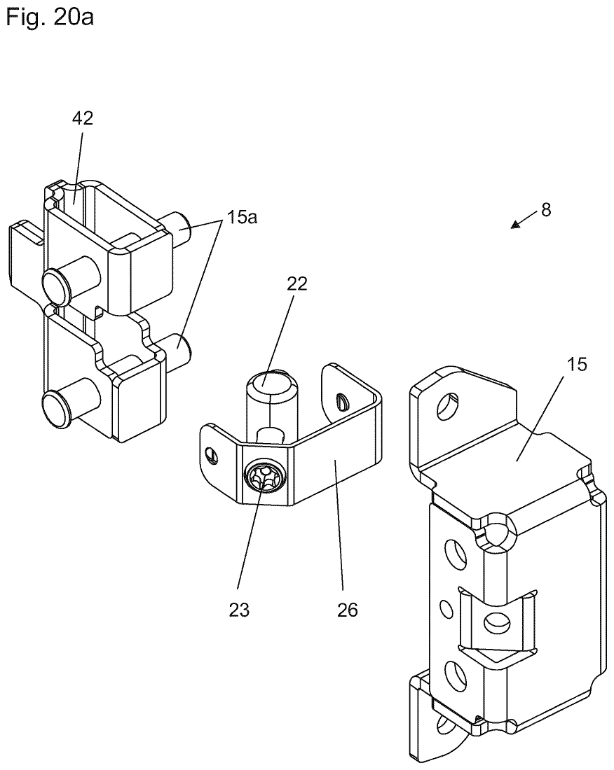

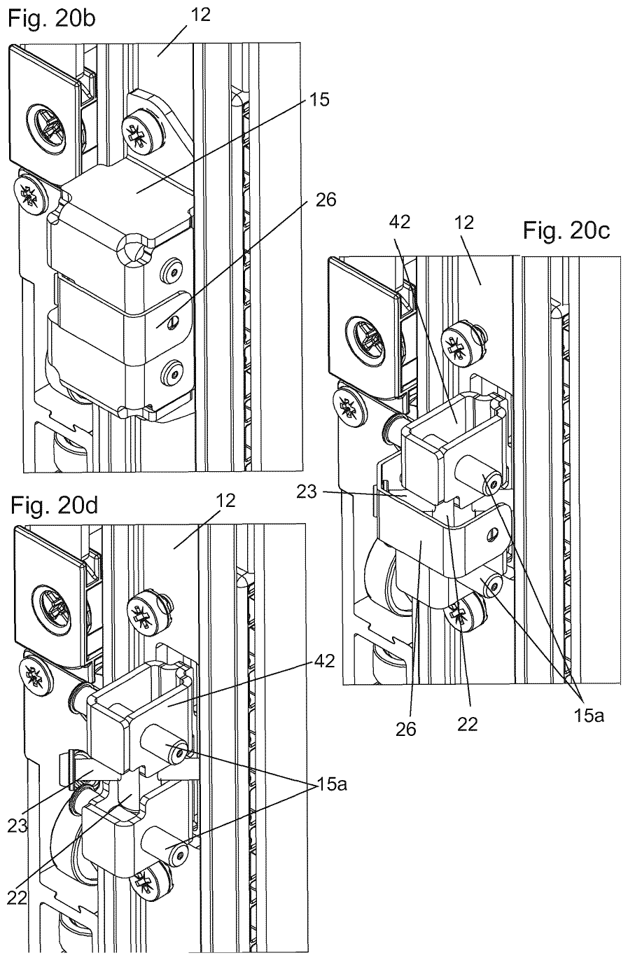

FIGS. 20a to 20d show various views of a further embodiment of the side adjustment device 8. This is a lower side adjustment device 8 of the guide arrangement 1 according to FIG. 18. The side adjustment device 8 according to this embodiment comprises a base body 15 which is connected to the holding element 12 in a movement-coupled manner. A connecting body 42 is displaceably mounted in the base body 15 on guide pins 15a. Furthermore, the connecting body 15 is connected to the carrier 5 in a movement-coupled manner.

A side adjustment element 22 is displaceably mounted in the connecting body 42. The side adjustment element 22 has a counter-thread 22b which is in engagement with a thread of a second actuating element 23. The second actuating element 23 is rotatably but axially non-displaceably mounted on the base body 15 via a bearing device 26. By actuating—in this case, rotating—the second actuating element 23, the base body 15, and thus the holding element 12, is displaced relative to the connecting body 42, and thus the carrier 5, in the direction orthogonal to the longitudinal extension L of the carrier 5.

The holding element 12, and thus the hinges 6 and the movable furniture part 101, is accordingly adjustable relative to the stationary furniture part 102 in the direction orthogonal to the longitudinal extension L of the carrier 5. In this way, a side adjustment according to FIGS. 2g and 2h can be implemented.

### LIST OF REFERENCE NUMERALS

1 guide arrangement
2 guide system
3 guide
4 guide device
4a carriage
4b roller
4c connecting element
4d bearing pin
4e opening
4f support element
4g elongated holes
5 carrier
5a end region
5b end region
5c counter-thread
6 hinge
7 height adjustment device
7a base body
7b groove
7c bearing element
8 side adjustment device
9 inclined surface
10 first actuating element
10a thread
11 height adjustment element
11a counter-thread
11b connecting pins
11c projection
12 holding element
12a screws
13 further inclined surface
14 abutment element
15 base body
15a guide pin
16 intermediate element
17 compensation device
18 cable
18a first end
18b second end
19 deflection roller
20 inclination adjustment device
21 fastening device
22 side adjustment element
22a guide slot
22b counter-thread
23 second actuating element
23a spiral-shaped projection
23b thread
24 guide pin
25 toothing
26 bearing element
27 third actuating element
27a thread
28 swivel element
28a counter-thread
28b bracket
29 clamping device
29a clamping jaws
30 mounting body
30a elongated holes
31 deflection element
32 cable tensioning device
32a base body
32b holding element
32c actuating element
32d torque limiter
33 depth adjustment device
34 upper deflection roller
35 lower deflection device
36 upper deflection device
37 rear deflection device
38 transition element
38a first elongated holes
38b second elongated holes
39 depth adjustment element
40 fourth actuating element
41 holding body
42 connecting body
100 furniture
101 movable furniture part
101a door leaf
102 stationary furniture part
103 shaft
104 furniture carcass
104a interior
105 carriage
106 rail

1. A guide arrangement for guiding a movable furniture part, in particular a sliding door or folding-sliding door, relative to a stationary furniture part, in particular a furniture wall, comprising:
at least one guide system with a guide to be arranged on the stationary furniture part and a guide device displaceably mounted on the guide,
a carrier, to which the movable furniture part is to be fastened and which is connected to the guide device in a movement-coupled manner,
at least two hinges for the pivotable mounting of the movable furniture part on the carrier, and
a height adjustment device for adjusting the at least two hinges relative to the at least one guide system in a direction parallel to a longitudinal extension of the carrier,
wherein the height adjustment device has at least one inclined surface, preferably at least one wedge, for adjusting the at least two hinges relative to the at least one guide system in the direction parallel to the longitudinal extension of the carrier, and that a side adjustment device is provided for adjusting the at least two hinges relative to the at least one guide system in a direction orthogonal to the longitudinal extension of the carrier, wherein the height adjustment device and the side adjustment device form a common structural unit.

2. The guide arrangement according to claim 1, wherein the at least two hinges are adjustable in the direction parallel to a longitudinal extension of the carrier independently of adjustment in the direction orthogonal to the longitudinal extension of the carrier and/or wherein the at least two hinges are adjustable in the direction orthogonal to a longitudinal extension of the carrier independently of adjustment in the direction parallel to the longitudinal extension of the carrier.

3. The guide arrangement according to claim 1, wherein the carrier is enclosed at least in sections by the guide device.

4. The guide arrangement according to claim 1, wherein the carrier has two end regions, wherein a respective side adjustment device is arranged in each of the two end regions, and wherein the at least one height adjustment device is arranged in at least one, preferably exactly one, of the at least two end regions.

5. The guide arrangement according to claim 1, wherein at least two guide systems are provided, preferably wherein the at least two guide systems are to be arranged on the stationary furniture part parallel to one another and/or spaced apart from one another in the direction parallel to the longitudinal extension of the carrier.

6. The guide arrangement according to claim 1, further comprising a first actuating element for actuating the height adjustment device, preferably wherein the first actuating element, even when the movable furniture part is fastened to the carrier, is accessible, preferably wherein the first actuating element is aligned:
parallel to the direction orthogonal to the longitudinal extension of the carrier, or
obliquely, preferably at an angle of 45°, to the direction orthogonal to the longitudinal extension of the carrier, or
orthogonal to the direction orthogonal to the longitudinal extension of the carrier.

7. The guide arrangement according to claim 6, wherein the first actuating element has a thread, wherein the at least one inclined surface is movable by actuating, preferably rotating, the first actuating element, preferably wherein the thread engages with a mating thread arranged on or in a height adjustment element having the at least one inclined surface.

8. The guide arrangement according to claim 1, wherein the at least two hinges are arranged directly on the carrier or wherein at least one retaining element is provided, wherein the at least two hinges are arranged on the at least one retaining element and wherein the at least one retaining element is slidably arranged on the carrier.

9. The guide arrangement according to claim 1, wherein the at least one inclined surface is displaceably mounted on or in the guide device in a further direction orthogonal to the longitudinal extension of the carrier in a direction different from the direction orthogonal to the longitudinal extension.

10. The guide arrangement according to claim 1, wherein a further inclined surface is provided which comes into contact with the at least one inclined surface, preferably wherein the further inclined surface is made of a friction-reducing material or is coated with a friction-reducing material.

11. The guide arrangement according to claim 10, wherein the further inclined surface is connected to the carrier in a movement-coupled manner, preferably such that the carrier is displaceable in the direction orthogonal to its longitudinal extension relative to the further inclined surface and/or the guide device.

12. The guide arrangement according to claim 10, wherein the inclined surface is displaceably mounted on or in the guide device in the direction parallel to the longitudinal extension of the carrier.

13. The guide arrangement according to claim 1, wherein the at least one inclined surface is arranged on or in the carrier and/or is connected to the carrier in a movement-coupled manner.

14. The guide arrangement according to claim 13, further comprising an abutment element on which the at least one inclined surface comes to rest, wherein the abutment element is connected to the guide device.

15. The guide arrangement according to claim 1, wherein for adjusting the at least two hinges relative to the at least one guide system in the direction parallel to the longitudinal extension of the carrier, the carrier is adjustable via the at least one height adjustment device relative to the at least one guide system in the direction parallel to a longitudinal extension of the carrier, and/or wherein for adjusting the at least two hinges in the direction orthogonal to the longitudinal extension of the carrier, the carrier is adjustable via the at least one side adjustment device relative to the at least one guide system in the direction orthogonal to the longitudinal extension of the carrier.

16. The guide arrangement according to claim 8, wherein the height adjustment device has a base body and an intermediate element which is slidably mounted on or in the base body in the direction parallel to the longitudinal extension of the carrier, wherein the base body is connected to the at least one retaining element and the intermediate element is connected to the carrier.

17. The guide arrangement according to claim 16, wherein the at least one inclined surface is displaceably mounted on or in the base body in the direction orthogonal to the longitudinal extension of the carrier.

18. The guide arrangement according to claim 16, wherein the intermediate element has a further inclined surface which comes into contact with the at least one inclined surface.

19. The guide arrangement according to claim 1, wherein the guide arrangement comprises:
a compensation device for compensating for a tilting moment of the carrier or of the at least one movable furniture part arranged thereon about a tilting axis by means of a restoring moment, wherein the compensation device comprises at least one cable pull device with at least one cable,
at least one deflection roller connected to the guide device in a movement-coupled manner for deflecting the at least one cable, and
an inclination adjustment device for adjusting an inclination of the movable furniture part,
wherein, via the inclination adjustment device, the carrier is movable relative to the at least one deflection roller, preferably in a direction orthogonal to a longitudinal extension of the carrier, and/or that the inclination adjustment device comprises at least one fastening device for fastening the at least one cable, wherein the at least one fastening device is displaceable relative to the carrier, preferably in a direction parallel to the longitudinal extension of the carrier.

20. The guide arrangement according to claim 1, wherein the at least one side adjustment device comprises a side adjustment element, wherein:
the side adjustment element is mounted on or in the carrier so as to be displaceable in the further direction orthogonal to the longitudinal extension of the carrier, preferably wherein the side adjustment element is displaceable by actuating, preferably by rotating, a second actuating element, wherein the lateral adjustment element has at least one guide cam, preferably wherein the guide cam is designed as a groove, and wherein the side adjustment device has at least one guide pin, wherein the guide pin is connected to the guide device in a movement-coupled manner, or
the side adjustment element is rotatably arranged on or in the guide device, wherein the side adjustment element has a spiral projection, preferably wherein a center point of the spiral projection lies substantially on an axis of rotation of the side adjustment element, and wherein a toothing is provided on the carrier, wherein the toothing engages with the spiral projection of the side adjustment element.

21. A piece of furniture comprising at least one stationary furniture part, in particular a furniture wall, and at least one movable furniture part, in particular a sliding door or folding-sliding door, and the guide arrangement according to claim 1 for guiding the at least one movable furniture part on the stationary furniture part, preferably wherein the at least one stationary furniture part at least partially delimits a shaft-like cavity of the piece of furniture in which the at least one movable furniture part can be arranged.
